(19) United States
(12) Patent Application Publication
(10) Pub. No.: US 2011/0147490 A1
(43) Pub. Date: Jun. 23, 2011

(54) SHOWER HEAD STRUCTURE WITH FAUCET FUNCTION

(75) Inventor: Tianyu Chen, Xiamen (CN)

(73) Assignee: XIAMEN SOLEX HIGH-TECH INDUSTRIES CO., LTD., Fujian (CN)

(21) Appl. No.: 12/988,530

(22) PCT Filed: Aug. 18, 2009
(86) PCT No.: PCT/CN2009/073325

§ 371 Date: Oct. 19, 2010

(30) Foreign Application Priority Data
Sep. 9, 2008 (CN) 200810071756.X

(51) Int. Cl. B05B 15/00

(52) U.S. Cl. 239/289

(57) ABSTRACT

A shower head structure with faucet function comprises a water outlet body and a handle. The water outlet body is provided with a shower head water outlet device and a faucet water outlet. The water outlet body is provided with two separate waterways which are respectively connected with the shower head water outlet device and the faucet water outlet. The handle is provided with a water inlet cavity. The water outlet body is hermetically pivotally connected with the handle. The water outlet body rotates relative to the handle in order that the water inlet cavity of the handle is communicated with one of the waterways of the water outlet body.

### FIELD OF THE INVENTION

The present invention relates to a sanitary ware product, especially relates to a shower head structure with faucet function.

### BACKGROUND OF THE INVENTION

The shower head and faucet are generally equipped in the family bathroom individually. The shower head is used for shower by connecting with the water heater, and the faucet are usually installed on the basin and connected with the water inlet pipe. The water heater provides hot water to the shower head, but the faucet may not be provided with hot water. So the user usually takes hot water from the shower head, however, since the flowing area and the flowing angle of the shower head are relatively large, it will be inconvenient for taking the hot water.

### SUMMARY OF THE INVENTION

The object of the present invention is to provide a shower head structure with faucet function, it will fully utilize the bathroom resources to meet the consumer's using requirements.

In order to realize the above purpose, the technical solution of the present invention is: a shower head structure with faucet function, it comprises a water outlet body and a handle; the water outlet body is provided with a shower head water outlet device and a faucet water outlet, the water outlet body is provided with two separate waterways which are respectively connected with the shower head water outlet device and the faucet water outlet, the handle is provided with a water inlet cavity; the water outlet body is hermetically pivotally connected with the handle, the water outlet body rotates relative to the handle in order that the water inlet cavity of the handle is communicated with one of the waterways of the water outlet body.

Said water outlet body is pivotally connected with the handle with an axial connecter.

Said water outlet body is pivotally connected with the handle with a radial connecter.

Said water outlet body and the handle are column-shaped, the shower head water outlet device and the faucet water outlet are respectively disposed on the two sides of the water outlet body.

The contacting surfaces between the water outlet body and the handle are inclined surfaces, when the water outlet body and the handle are on a same axial, the water inlet cavity will communicate with the faucet water outlet; when the water outlet body rotate relative to the handle with 180 degrees, the water inlet cavity will communicate with the faucet water outlet, and the direction of the faucet water outlet faces downward.

After applying the above solution, the shower head of the present invention is constructed by a water outlet body and a handle which can rotate relative to each other, meanwhile the shower head water outlet device and the faucet water outlet are independently disposed, so when the shower head is not applied for shower, the shower head will be transferred into faucet by rotating the water outlet body, and faucet function will be realized by setting the shower head on the basin, so the user can conveniently take hot water from the water heater by said shower head when the basin does not supply hot water, it will be flexibly used, and a single shower head will have multiple functions, the bathroom resources will be fully utilized, moreover the sanitary wares will be saved.

### BRIEF DESCRIPTION OF THE DRAWINGS

FIG. 1 illustrates the first embodiment of the present invention when the shower head function works;

FIG. 2 illustrates the first embodiment of the present invention when the faucet function works;

FIG. 3 illustrates the second embodiment of the present invention when the shower head function works;

FIG. 4 illustrates the first embodiment of the present invention when the faucet function works.

### DETAILED DESCRIPTION OF THE EMBODIMENTS

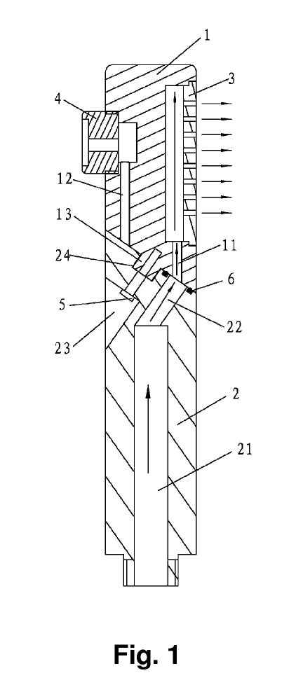

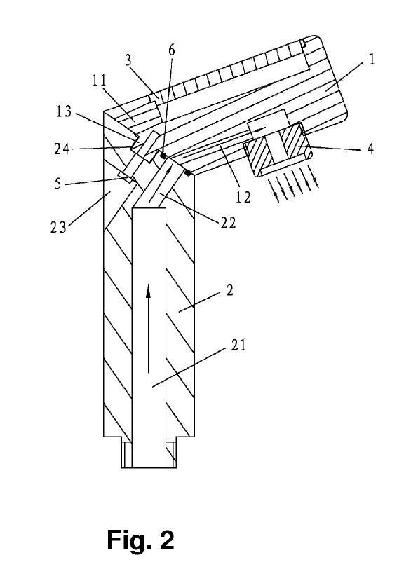

The first embodiment of the present invention is showed in FIG. 1 and FIG. 2, the shower head structure with faucet function is constructed by a water outlet body 1 and a handle 2, and the water outlet body 1 and the handle 2 forms a column body;

Wherein the two sides of the water outlet body 1 are respectively disposed with a shower head water outlet device 3 and a faucet water outlet 4, the water outlet body 1 has two separate waterways 11, 12 which are respectively connected with the shower head water outlet device 3 and the faucet water outlet 4; the lower end surface of the water outlet body forms an inclined surface, the center of said inclined surface has a protruding column 13 which is vertical to the inclined surface; the water inlet of the waterway 11 is set on the lower part of the inclined surface, and the water inlet of the waterway 12 is set on the upper part of the inclined surface, that is, they are respectively set on the two sides of the protruding column 13.

The handle 2 has a water inlet cavity 21 corresponding to the inclined surface of the water outlet body, the upper end surface of said handle 2 also forms an inclined surface, the center of said inclined surface is depressed to form a sinking groove 24, the side wall of the handle 2 has a notch 23 on the back surface of said sinking groove 24; further a water outlet is disposed on the lower part of the inclined surface, the periphery of the water outlet has a sealing gasket 6, an inclined water inlet pipe 22 is formed on the upper part of the water inlet cavity 21 for connecting the water inlet cavity 21 and the water outlet.

When the water outlet body 1 is assembled with the handle 2, the inclined surfaces between them are cooperated with each other oppositely, that is, the protruding column 13 of the water outlet body 1 extends and disposed in the sinking groove 24 of the handle 2, a bolt 5 extends and passes through the sinking groove 24 and the protruding column 13 from the notch 23 of the handle 2 in order that the water outlet body 1 and the handle can be pivotally connected.

As showed in FIG. 1, when the water inlet of the waterway 11 of the water outlet body 1 is set on the lower part of the inclined surface of the handle 2, the water outlet body 1 and the handle 2 will form a column-shaped shower head, that is, said waterway 11 will communicate with the water inlet cavity 21 of the handle 2, at this time the water flows into the shower head water outlet device 3, the shower head will be served as an ordinary shower head for shower.

As showed in FIG. 2, when the water outlet body 1 rotates relative to the handle 2 around the protruding column 13 with 180 degrees, the waterway 12 of the water outlet body 1 will communicate with the water inlet cavity 21 of the handle 2, at the same time an included angle will be formed between the water outlet body 1 and the handle 2, the direction of the faucet water outlet 4 faces downward, the water will flow into the faucet water outlet 4 from the waterway 12, so the shower head will be switched as a faucet, the faucet function will be realized by setting said handle 2 on the basin.

Certainly, the manners of pivotal connection between the water outlet body 1 and the handle 2 can be various, it should not be limited within the above mentioned axial pivotal connection.

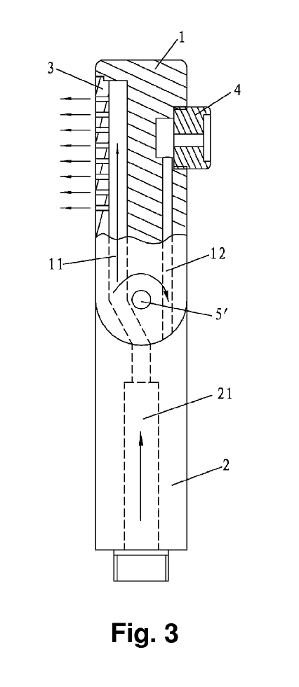

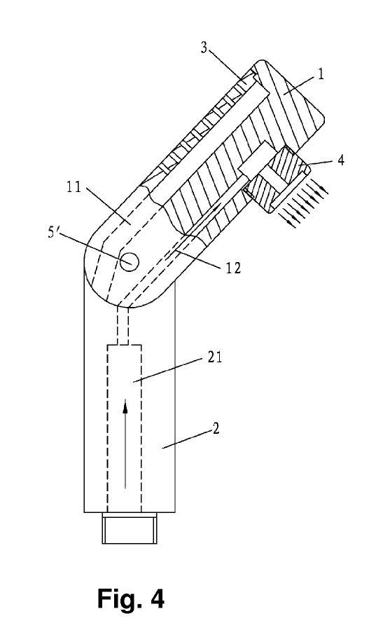

The second embodiment 2 of the present invention is showed in FIG. 3 and FIG. 4, the shower head is also formed by the pivotal connection of the water outlet body 1 and the handle 2, the two sides of the water outlet body 1 are respectively disposed with a shower head water outlet device 3 and a faucet water outlet 4, there are two separate waterways 11 and 12 disposed in the water outlet body 1 and respectively connected with the shower head water outlet device 3 and the faucet water outlet 4; the end surface of the water outlet body is curve.

The handle 2 has a water inlet cavity 21.

When the water outlet body 1 is assembled with the handle 2, they are radially and pivotally connected with a bolt 5′, when the water outlet body 1 and the handle 2 are set on a same axial, the water inlet cavity 21 of the handle 2 will communicate with the waterway 11 of the water outlet body 1, the water will flow from the shower head water outlet device 3 of the water outlet body 1, at this time the shower head is served as an ordinary shower head for shower.

As showed in FIG. 4, when the water outlet body 1 rotates relative to the handle 2 around the bolt 5′ with a certain included angle, the rotational angle will be identified by setting marks on the water outlet body 1 and the handle 2, so the waterway 12 of the water outlet body 1 will communicate with the water inlet cavity 21 of the handle 2, the direction of the faucet outlet 4 faces downward, the water will flow into the faucet water outlet 4 from the waterway 12, at this time the shower head is switched as a faucet, the faucet function will be realized by setting said handle 2 on the basin.

### INDUSTRIAL APPLICABILITY

The shower head of the present invention will be formed by the water outlet body 1 and the handle 2 which can rotate relative to each other, meanwhile the shower head water outlet device 3 and the faucet water outlet 4 of the water outlet body 1 are set independently, so when said shower head is not used for shower, the shower head will be switched as faucet by rotating the water outlet body 1, and faucet function will be realized by setting the shower head on the basin, so the user can conveniently take hot water from the water heater by said shower head when the basin does not supply hot water, it will be flexibly used, and the single shower head will have multiple functions, the bathroom resources will be fully utilized, moreover the sanitary wares will be saved, it has a good industrial applicability.

What is claimed is:

1. A shower head structure with faucet function, wherein it comprises a water outlet body and a handle; the water outlet body is provided with a shower head water outlet device and a faucet water outlet, the water outlet body is provided with two separate waterways which are respectively connected with the shower head water outlet device and the faucet water outlet, the handle is provided with a water inlet cavity; the water outlet body is hermetically pivotally connected with the handle, the water outlet body rotates relative to the handle in order that the water inlet cavity of the handle is communicated with one of the waterways of the water outlet body.

2. The shower head structure with faucet function according to claim 1, wherein the water outlet body is pivotally connected with the handle with an axial connecter.

3. The shower head structure with faucet function according to claim 1, wherein the water outlet body is pivotally connected with the handle with a radial connecter.

4. The shower head structure with faucet function according to claim 1, wherein the water outlet body and the handle are column-shaped, the shower head water outlet device and the faucet water outlet are respectively disposed on the two sides of the water outlet body.

5. The shower head structure with faucet function according to claim 2, wherein the contacting surfaces between the water outlet body and the handle are inclined surfaces, the water outlet body and the handle are axially and pivotally connected with a protruding column, when the water outlet body and the handle are on a same axial, the water inlet cavity will communicate with the faucet water outlet, and the direction of the faucet water outlet faces downward.

6. The shower head structure with faucet function according to claim 3, wherein the lower end surface of the water outlet body is curve, the water outlet body and the handle is radially and pivotally connected with a bolt, when the water outlet body and the handle are on a same axis, the water inlet cavity will communicate with the shower head water outlet device; when the water outlet body rotates relative to the handle around the bolt with a certain included angle, the water inlet cavity will communicate with the faucet water outlet, and the direction of the faucet water outlet faces downward.
